(19) United States
(12) Patent Application Publication
(10) Pub. No.: US 2009/0037946 A1
(43) Pub. Date: Feb. 5, 2009

(54) Dynamically displaying content to an audience

(76) Inventors: Nelson Liang An Chang, San Jose, CA (US); Niranjan Damera-Venkata, Mountain View, CA (US); Yuxin Liu, Mountain View, CA (US); David Wu, San Diego, CA (US); Don Ouchida, Corvallis, OR (US); Lynn Katon, Independence, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,362

(22) Filed: Jul. 31, 2007

(51) Int. Cl. H04N 7/173

(52) U.S. Cl. 725/24

(57) ABSTRACT

A method of dynamically displaying content to an audience is disclosed. The method includes displaying content to the audience wherein at least a portion of the audience is proximate a display means, capturing a plurality of responses from the audience, aggregating the plurality of responses and dynamically updating the displayed content based on the aggregated plurality of responses.

### BACKGROUND

Because of their passive nature and similarity to regular billboard/television advertising, typical content found on today's printed and digital signage in public venues are easy to ignore. For large displays, it is important to create compelling experiences that can repeatedly captivate an audience. If done well, such experiences can also serve as a means for creating buzz through word of mouth while simultaneously increasing advertising and business opportunities. However, conventional signage advertising is “open looped” meaning that the content providers and advertisers think they know in advance what will appeal to the general audience and display content hoping that the assumptions are correct. Sometimes this is true, but more times than not, this is not the case.

### BRIEF DESCRIPTION OF THE DRAWINGS

FIG. 1 is a high-level flowchart of a method in accordance with an embodiment.

FIG. 2 illustrates a dynamic display system in accordance with an embodiment.

FIG. 3 illustrates an alternate embodiment of a dynamic display system in accordance with an embodiment.

FIG. 4 illustrates another embodiment of a dynamic display system in accordance with an embodiment.

### DETAILED DESCRIPTION

As shown in the drawings for purposes of illustration, a method and system for dynamically displaying content to an audience is disclosed. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

In an embodiment, the method and system are designed to create a means to improve audience engagement by allowing audience “voting” to determine what content is being displayed. Accordingly, the method and system enables the audience to have a vested interest and decide together as a group what content will be viewed. Additionally, the method and system can provide content providers and advertisers with more insight into audience preferences and rankings. Finally, the method and system could also be used to provide public opinion on future product/brand design and marketing, thereby reducing development time and/or increasing future sales for the companies involved.

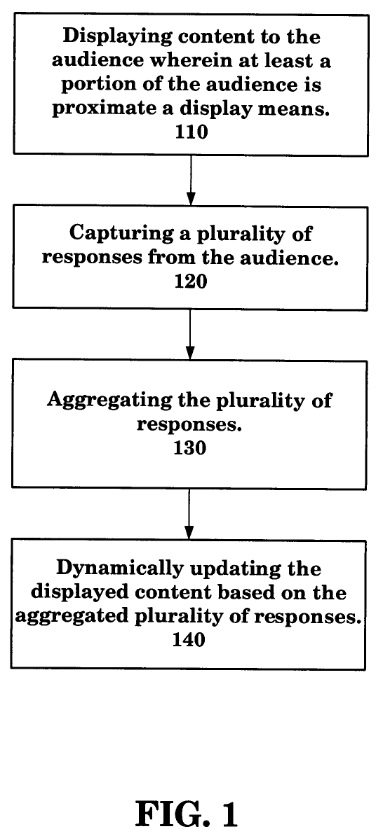

FIG. 1 is a flowchart of a method in accordance with an embodiment. A first step 110 involves displaying content to the audience wherein at least a portion of the audience is proximate a display means. A next step 120 involves capturing a plurality of responses from the audience. A third step 130 involves aggregating the plurality of responses. A final step 140 includes dynamically updating the displayed content based on the aggregated plurality of response. Again, by enabling the audience to have a vested interest and decide together as a group what content will be viewed, a means to improve audience engagement is created.

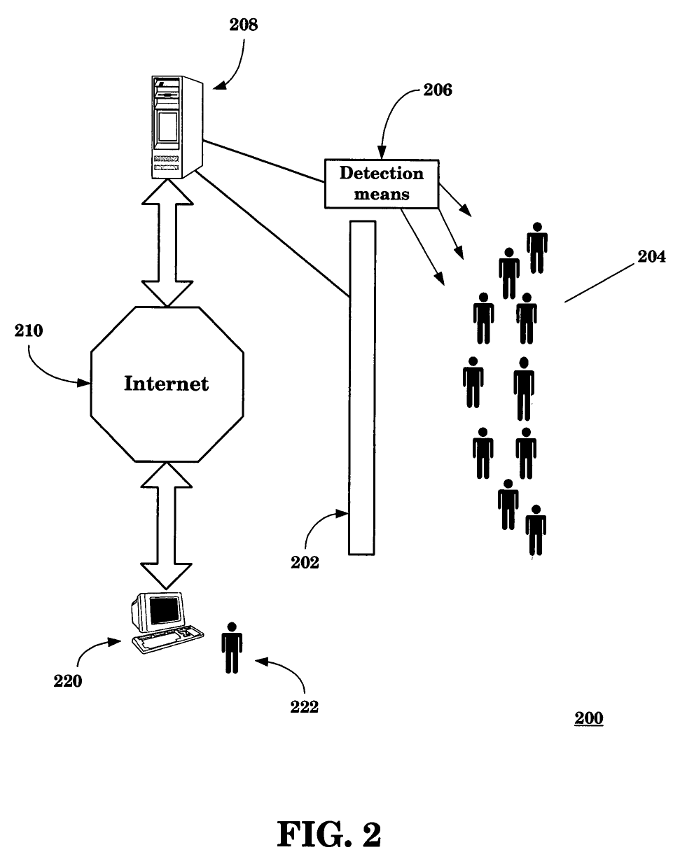

FIG. 2 is an illustration of a system 200 in accordance with an embodiment. The system 200 includes display means 202 for displaying a content to the audience 204 wherein at least a portion of the audience is proximate the display means 202, detection means 206 for detecting a plurality of responses from the audience 204 and a content server 208 coupled to the detection means 206 and the display means 202 for controlling the content being displayed by the display means 202, aggregating a plurality of responses from the audience 204 and dynamically updating the content being displayed based on the plurality of responses from the audience 204.

The content server 208 may operate in a networked environment using logical connections to one or more remote computers, such as remote computer 220 with at least one remote audience participant 222. The remote computer 220 may be a personal computer, a server, a network PC, a personal digital assistant (PDA), a cellular telephone or any of a variety of computing devices. In an embodiment, the logical connection depicted in FIG. 2 is the Internet 210.

The Internet 210 is a global web of interconnected computers and computer networks, integrates local area networks (LANs) located in various entities, such as businesses, libraries, federal agencies, institutes of learning, and research organizations into a single communication network. The Internet uses a common communication protocol suite, known as a Transmission Control Protocol/Internet Protocol (TCP/IP), which was specifically designed for the interconnection of different computer systems.

Although logical connection is described in the context of being the Internet, one of ordinary skill in the art will readily recognize that the logical connection could be any network or interconnecting protocol while remaining within the spirit and scope of the present inventive concepts.

In an embodiment, display means 202 is capable of displaying an audio-video stimulus and can be anything that would satisfy the intended function of a large-area public display perceptible by a number of people in a manner where close proximity to the display is not necessary. Video walls could be used, depending on the desired resolution demanded by the data stream. If more sophisticated display formats, such as image scrolls, pans and zooms, as well as a variety of text effects are desired, higher resolution displays may be employed. Regardless, so long as a display means 202 can adequately communicate the content in a perceptible manner, the display means 202 will be satisfactory. Furthermore, the display means 202 could capable of simultaneously displaying a plurality of different content. For example, the display means 202 could be a large tiled display that includes a plurality of individual tiles whereby each tile is capable of displaying a separate content stream.

The content server 208 may be any type of personal computer, portable computer, or workstation computer that includes a processing unit, a system memory, and a system bus that couples the processing unit to the various components of the computer. The processing unit may include one or more processors, each of which may be in the form of any one of various commercially available processors. Generally, each processor receives instructions and data from a read-only memory and/or a random access memory.

The system memory typically includes a read only memory (ROM) that stores a basic input/output system (BIOS) that contains start-up routines for the computer, and a random access memory (RAM). The system bus may be a memory bus, a peripheral bus or a local bus, and may be compatible with any of a variety of bus protocols, including PCI, VESA, Microchannel, ISA, and EISA. The computer 205 also may include a hard drive, a floppy drive, and CD ROM drive that are connected to the system bus by respective interfaces. The hard drive, floppy drive, and CD ROM drive contain respective computer-readable media disks that provide non-volatile or persistent storage for data, data structures and computer-executable instructions. Other computer-readable storage devices (e.g., magnetic tape drives, flash memory devices, and digital versatile disks) also may be used with the content server 208.

The term “server” may refer to both the hardware and software (the entire computer system) or just the software that performs the service. For example, server may refer to the server software in a computer that also runs other applications, or, it may refer to a computer system dedicated only to the server application. Also, different software modules could be deployed in the same system or across multiple different subsystems. Furthermore, the server could include more than one machine such as in cluster/grid computing, etc.

During operation, the overall system 200 continuously displays content from the server 208. This content could be in the form of a series of questions (e.g. “how many like x?) or a multiple-choice question. The questions could be related to any topic of interest (e.g. trivia questions, sports questions, public interest questions, or even prototype/future product suggestions). Other types of content could also be used. For example, the display means 202 could show four different movie trailers at the same time and based on the aggregated response of the audience, one of the movies could be selected to be viewed. For example, different spots on the audience floor could respectively correspond to a vote for each movie. Consequently, when a predetermined amount of people in the crowd congregated in a particular spot, thus “voting” for a particular movie, the corresponding movie is triggered and is subsequently shown on the entire display.

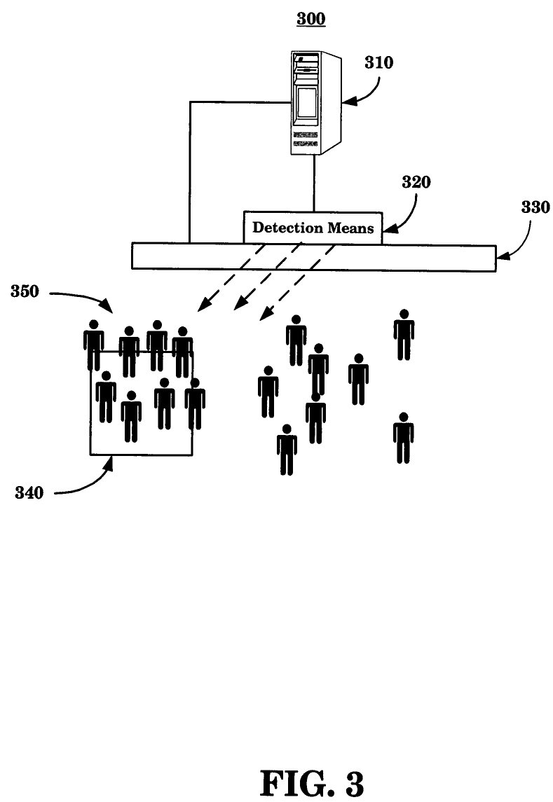

FIG. 3 is an illustration of the above-delineated embodiment. FIG. 3 shows a system 300 that includes a content server 310 coupled to a detection means 320 and a display means 330. Also, shown is a designated area 340. In this particular embodiment, the detection means 320 is configured to recognize that the designated area 340 corresponds to a particular vote that relates to the content being displayed by the display means 330. Accordingly, when a predetermined number of people 350 are detected by the detection means 320 to be in the designated area 340, the content being displayed is updated by the content server 310 based on whatever content is associated with the designated area 340.

Referring back to FIG. 1, step 120 could be accomplished in a variety of ways. In an embodiment, detection means 206 is vision-based. Vision-based detection captures the audience's view via image-processing techniques (background subtraction, silhouette detection, etc.) to distill individual audience voting. For example, audience participants positioned near the display could simply perform some type of gesture (e.g. raise a hand) in response to the content as a way of submitting a vote. Also, audience participants could line up and form different shapes (e.g. those participants who vote ‘a’, cluster together and form the letter ‘a’, etc.).

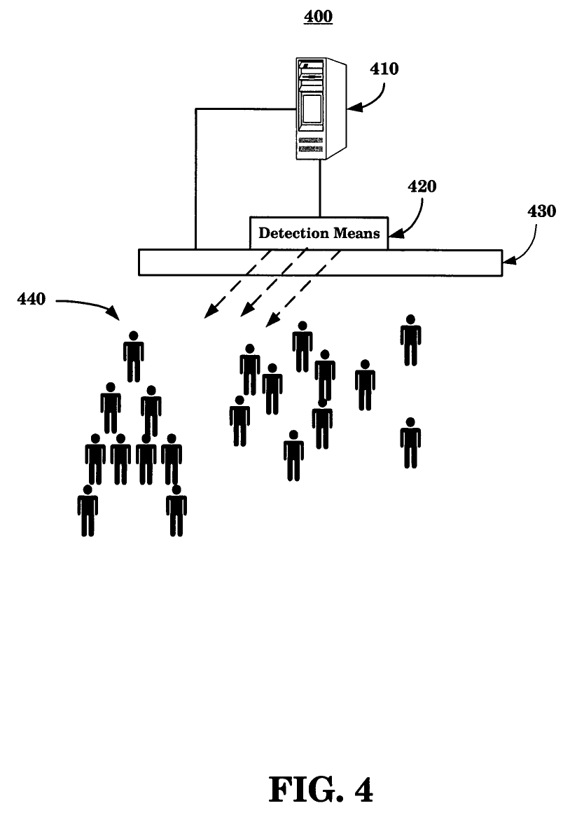

FIG. 4 is an illustration of the above-described embodiment. FIG. 4 shows a system 400 that includes a content server 410 coupled to a vision-based detection means 420 and a display means 430. In this particular embodiment, the vision-based detection means 420 is configured to recognize shapes formed by the people 440 in the audience whereby a particular shape corresponds to a particular vote that relates to the content being displayed by the display means 430. Accordingly, if the content server 410 displays content such as a question with a multiple choice of answers (e.g. A, B, C, etc.), a group of people 440 can be detected by the vision-based detection means 420 to form a particular shape, in this case the letter “A”. Consequently, the content being displayed is updated by the content server 410 based on whatever content is associated with the “A” response to the displayed question.

In an alternate embodiment, the detection means is audio-based. Audio-based detection incorporates a microphone or some other similar type of audio capturing component. For example, the volume of the audience response (cheering, booing, etc.) could be utilized to determine the audience vote regarding the displayed content. Alternatively, with additionally audio equipment (e.g. microphone array, voice recognition software), the system could detect and recognize actual spoken responses from the audience and tally the number of such responses in the voting process (e.g. recognizing groups of people saying ‘a’ or other letters, etc.).

Although the above disclosed embodiments are described in the context of employing vision and audio based detection, one of ordinary skill in the art will readily recognize that a variety of detection means could be employed while remaining within the spirit and scope of the present inventive concept.

In an embodiment, step 130 is accomplished via the content server 208. Accordingly, the content server 208 receives data from the detection means 206 and filters out the relevant audience response(s). The response(s) are then aggregated to determine a majority response (e.g. tally number of hands raised, tally number of audible responses, etc.). The responses are aggregated over some predetermined duration of time or in some cases, a minimal response level could be employed whereby the content server 208 will not ‘react’ until this level has been met.

Once the response have been aggregated, the content being displayed by the content server 208 is dynamically updated in real-time based on the aggregated responses. For example, if separate content streams are being displayed, the content streams could be updated to display the content that receives the majority vote. Additionally, the content being displayed to the remote participants could be automatically updated based on the aggregated vote as well. Furthermore, in the case where content being displayed is a future product design, the color or other attributes of the product being displayed can be dynamically updated based on the aggregated vote of the audience.

A method and system of dynamically displaying content to an audience is disclosed. The method includes displaying content to the audience wherein at least a portion of the audience is proximate a display means, capturing a plurality of responses from the audience, aggregating the plurality of responses and dynamically updating the displayed content based on the aggregated plurality of responses. As result of the implementation of the disclosed method, a means to improve audience engagement is created thereby allowing audience “voting” to determine what content is being displayed. Additionally, the method and system can provide content providers and advertisers with more insight into audience preferences and rankings. Finally, the method and system could also be used to provide public opinion on future product/brand design and marketing, thereby reducing development time and/or increasing future sales for the companies involved.

The above-described embodiment may also be implemented, for example, by operating a computer system to execute a sequence of computer readable instructions. Accordingly, a computing device typically includes at least some form of computer readable media. Computer readable media can be any available media that can be accessed by a computing device. By way of example, and not limitation, computer readable media may comprise computer storage media and communications media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage device, or any other medium which can be used to store the desired information and which can be accessed by a computing device.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Accordingly, an alternate embodiment includes a computer readable medium having computer executable components for correcting luminance non-uniformity in a tiled projection system.

Without further analysis, the foregoing so fully reveals the gist of the present inventive concepts that others can, by applying current knowledge, readily adapt it for various applications without omitting features that, from the standpoint of prior art, fairly constitute the characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. A method of dynamically displaying content to an audience comprising:
displaying content to the audience wherein at least a portion of the audience is proximate a display means;
capturing a plurality of responses from the audience;
aggregating the plurality of responses; and
dynamically updating the displayed content based on the aggregated plurality of responses.

2. The method of claim 1 wherein the content comprises a plurality of questions related to a predetermined topic.

3. The method of claim 1 wherein capturing the plurality of responses further comprises implementing vision-based techniques.

4. The method of claim 1 wherein capturing the plurality of responses further comprises utilizing audio input from the audience.

5. The method of claim 1 wherein the content further comprises a web-based presentation wherein at least a portion of the audience is remotely located.

6. The method of claim 1 wherein aggregating the plurality of responses further comprises aggregating a predetermined level of a particular response.

7. The method of claim 1 wherein dynamically updating the displayed content further comprises changing the displayed content in real time.

8. A computer program product for dynamically displaying content to an audience, the computer program product comprising a computer usable medium having computer readable program means for causing a computer to perform the steps of:
displaying content to the audience wherein at least a portion of the audience is proximate a display means;
capturing a plurality of responses from the audience;
aggregating the plurality of responses; and
dynamically updating the displayed content based on the aggregated plurality of response.

9. The computer program product of claim 8 wherein the content comprises a plurality of questions related to a predetermined topic.

10. The computer program product of claim 8 wherein the plurality of responses further comprises implementing vision-based techniques.

11. The computer program product of claim 8 wherein capturing the plurality of responses further comprises utilizing audio input from the audience.

12. The computer program product of claim 8 wherein the content further comprises a web-based presentation wherein at least a portion of the audience is remotely located.

13. The computer program product of claim 8 wherein aggregating the plurality of responses further comprises aggregating a predetermined level of a particular response.

14. The computer program product of claim 8 wherein dynamically updating the displayed content further comprises changing the displayed content.

15. A system for dynamically displaying content to an audience comprising:
a display means for displaying a content to the audience;
detection means coupled to the display means for detecting a plurality of responses from the audience wherein at least a portion of the audience is proximate a display means; and
a content server coupled to the detection means and the display means for aggregating the plurality of response and dynamically updating the content based on the plurality of responses.

16. The system of claim 15 wherein the display means is capable of simultaneously displaying a plurality of different content.

17. The system of claim 15 wherein the detection means further comprises visual based detection means.

18. The system of claim 15 wherein the detection means further comprises a web-based detection means.

19. The system of claim 15 wherein the detection means further comprises a audio-based detection means.

20. The system of claim 15 wherein aggregating the plurality of responses further comprises aggregating a predetermined level of a particular response.
